(19) United States
(12) Patent Application Publication
(10) Pub. No.: US 2010/0198604 A1
(43) Pub. Date: Aug. 5, 2010

(54) GENERATION OF CONCEPT RELATIONS

(75) Inventors: Yu Song, Pleasanton, CA (US); Doreen Cheng, San Jose, CA (US); Sangoh Jeong, Palo Alto, CA (US); Swaroop Kalasapur, Sunnyvale, CA (US)

Correspondence Address: Beyer Law Group LLP, P.O. BOX 1687, Cupertino, CA, 95015-1687, US

(73) Assignee: Samsung Electronics Co., Ltd., Suwon City (KR)

(21) Appl. No.: 12/363,662

(22) Filed: Jan. 30, 2009

(51) Int. Cl. G06Q 99/00

(52) U.S. Cl. 705/1.1

(57) ABSTRACT

Given a situation, an interest in a first object of interest can be determined. In the given situation, interest in a first object of interest is initially unknown and interest in a second object of interest is known. Data is obtained. The obtained data can, for example, include documents from the Internet or other forms of information from a network and/or database. The number of joint occurrences of the first object of interest and the second object of interest in the data is determined. Based on this number, at least one correlation value is determined. Based on the at least one correlation value, an interest value is determined. The interest value indicates the interest in the first object of interest in the given situation.

### BACKGROUND OF THE INVENTION

There are various situations in which correlating an interest with another interest can be useful. For example, at some e-commerce sites, shoppers receive recommendations based on previous purchases. A shopper who has purchased Disney-branded video games, for instance, may receive a suggestion to purchase Disney-branded toys as well. Relevant suggestions of this kind may generate increased sales.

The generation of such suggestions can involve relating one type of interest, e.g. Disney-branded video games, with another kind of interest e.g., Disney-branded toys. There are a variety of ways to relate different interests with one another.

One approach is to use ontology-based distances. FIG. 1A presents an example of such an approach. Ontological tree 100 relates primary topic “transportation” 106 to various subtopics, including subtopic “car” 102 and subtopic “vacation” 104. The strength of the relationship between subtopics is based on their distance from one another on the tree e.g., the subtopic 102 (“car”) and subtopic 104 (“vacation”) is based on the distance 108.

Another approach is based on attributes. FIG. 1B presents movie domain 110, which includes attributes genre 112, director 114, and actor 116. An e-commerce site that sells movies could base movie recommendations on attributes 112, 114 and 116. If a customer, for example, purchased an action movie that featured the actor Will Smith, then the user may receive recommendations for movies that belong to a similar genre (e.g., action and suspense) and/or movies that include the same actor (e.g., Will Smith.)

Another approach involves tagging. In this approach, a specific item (e.g., the animated Disney movie “Aladdin”) is associated with keywords and key phrases (i.e., “tags), such as “Disney,” “animation,” “fairy tale,” etc. In this example, a user's interest in the film “Aladdin” can be based on the number of tags that the user has already shown an interest in. For instance, based on the above tagging scheme, an e-commerce site may assume that a user with demonstrated interests in animation, fairy tale and Disney films would be much more interested in “Aladdin” than a user who has shown an interest in animation but none of the other tags.

These approaches, while effective in some applications, have weaknesses. They involve the creation of ontologies, domains, attributes, tags and/or other frameworks for each topic or concept. Human intervention is typically required to construct, maintain and update such frameworks. Some products, such as movies, are more easily structured as ontologies, domains and attributes than others. Additionally, the above approaches typically require collecting at least some user data that strongly relates to the sought-after interest. It may be difficult, for example, to estimate a user's interest in Disney movies if data about the user's media and movie preferences has not been gathered.

Accordingly, alternative techniques for predicting a user's interests would be desirable.

### SUMMARY OF THE INVENTION

Broadly speaking, the present invention relates to techniques for predicting an interest of a user.

One aspect of the invention pertains to determining interest in an object of interest in a given situation. In the given situation, interest in a first object of interest is unknown but interest in a second object of interest is known. Data is obtained. Data can, for example, include documents from the Internet or other forms of information from a network or database. In one embodiment, data is searched to find occurrences of the first object of interest and the second object of interest. The number of joint occurrences of the first object of interest and the second object of interest in the data is determined. Based on this number, at least one correlation value is determined. These correlation values represent the relationship between the first and second objects of interest and may, for example, relate to conditional probability, co-occurrence, correlation or other kinds of relationships. Based on the one or more correlation values, an interest value for the first object of interest is determined. The interest value indicates the interest in the first object of interest in the given situation.

An advantage of the above aspect is that it can determine a relationship between an unknown interest in a first object of interest and a known interest in a second object of interest, even when the objects of interest are not in the same domain and are not obviously related. By contrast, some conventional techniques for interest prediction depend on a strong, pre-existing relationship between the known interests (e.g., Disney movies) and the unknown interest (e.g., animated films in general.)

The invention can be implemented in numerous ways, including, for example, a method, an apparatus, a computer readable medium, and a computing system (e.g., one or more computing devices). Several embodiments of the invention are discussed below.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, wherein like reference numerals designate like structural elements, and in which:

FIG. 1A depicts an exemplary ontology.

FIG. 1B depicts an exemplary domain and various attributes.

FIG. 2A is a flow diagram illustrating a method of determining interest in a first object of interest in a given situation according to various embodiments of the invention.

FIG. 2B depicts the steps of FIG. 2A according to various embodiments of the invention.

FIG. 3 illustrates another method of determining interest in a first object of interest in a given situation according to various embodiments of the invention.

### DETAILED DESCRIPTION OF THE INVENTION

Broadly speaking, the present invention relates to techniques for predicting an interest of a user.

One aspect of the invention pertains to determining interest in an object of interest. Interest in a first object of interest is unknown but interest in a second object of interest is known. The first and second objects of interest can belong to entirely different domains and/or categories. Data is then obtained. This data, for example, can include documents from the Internet or other forms of information from a network or database. In one embodiment, data is searched to find occurrences of the first object of interest and the second object of interest. The number of joint occurrences of the first object of interest and the second object of interest in the data is determined. Based on this number, at least one correlation value is determined. These correlation values represent the relationship between the first and second objects of interest and may, for example, relate to conditional probability, co-occurrence, correlation or other kinds of relationships. Based on the one or more correlation values, an interest value for the first object of interest is determined. The interest value indicates the interest in the first object of interest.

It can be desirable to determine the degree of interest that a person has in a first object of interest, based on the person's interest in a second object of interest. This can be easier, as noted earlier, if the known interest in the second object of interest (e.g., Disney movies) is obviously connected with and therefore easily helps determine an interest in the second object of interest (e.g., someone who likes Disney movies probably likes animated family movies in general.) But sometimes data on such obviously related interests is scarce or unknown. This can pose a problem for ontology-, attribute- and tag-based approaches. As noted earlier, ontology-based approaches can require that the interests belong to the same domain or be part of the same predetermined tree or framework. Attribute-based and tagging-based approaches are less compatible with objects of interest that have fewer natural connections between them. It is easy, for instance, to link movie interests together by director or genre, but much more difficult to link interests in highly disparate fields, such as video games and classical music.

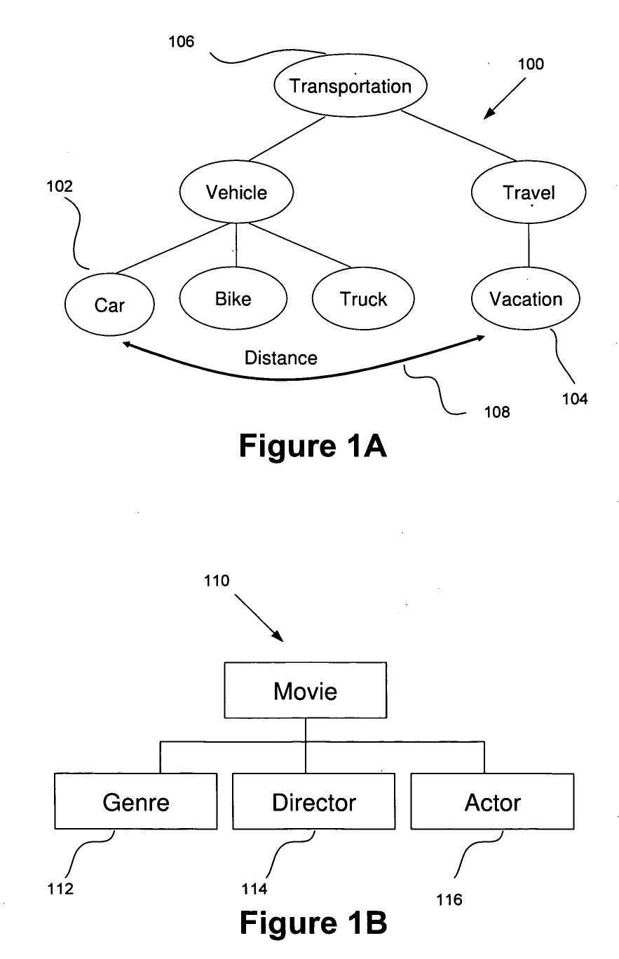

It will be appreciated that the invention can predict an interest in a first object of interest based on a known interest in a second object of interest, even when little or no data has been collected in direct connection with that first object and even when the first and second objects of interest are not part of the same domain. For the purposes of this application, when multiple objects are part of the same domain, it means that one is a feature and/or aspect of the other, or that both are features and/or aspects of the same item. By way of example, every movie has a director, multiple actors and a genre. Therefore, the objects “director,” “actor” and “genre” are part of the domain “movies.” Another way of understanding a domain is as a tree-like structure, in which each node can be a parent to children nodes. (The term “tree-like structure” is defined as a hierarchical tree structure of linked data nodes, as is commonly understood by those of ordinary skill in the art.) An example of such a structure is provided in FIG. 1A. Some existing prediction methods organize objects into such a tree structure and relate them based on the objects' relative position within the tree structure. In various embodiments of the present invention, however, the first and second objects of interest do not have to be in the same domain i.e., do not have to be represented as nodes in such a tree structure. The nature of the second object may be entirely different from the nature of the first object. In contrast to the approaches described in the Background of the Invention, the first and second objects of interest do not need to share predetermined tags or attributes. They do not need to be part of one or more predetermined, hierarchical taxonomies.

In one embodiment, the prediction of an interest in the first object of interest is further informed by considering the situation. For example, a particular person may be known to enjoy relaxing activities when at home during the evening, such as listening to classical music, playing video games or reading newspapers. At the office in the morning, the person may be more interested in productivity tools, such as time management programs or spreadsheet applications. Such situation-aware data can be accumulated and factored into the interest prediction process. In another embodiment, the interest prediction process is not situation-aware.

In one embodiment, data is obtained that contains joint occurrences of the first and second objects of interest. This data may include web pages and/or data items on the Internet that contain keywords or phrases relating to the two objects. The number of joint occurrences of the objects in such data is determined. Based on this number, a correlation value is determined that indicates a correlation between the first object of interest and the second object of interest. Based on this correlation value, an interest value for the unknown first object of interest is determined.

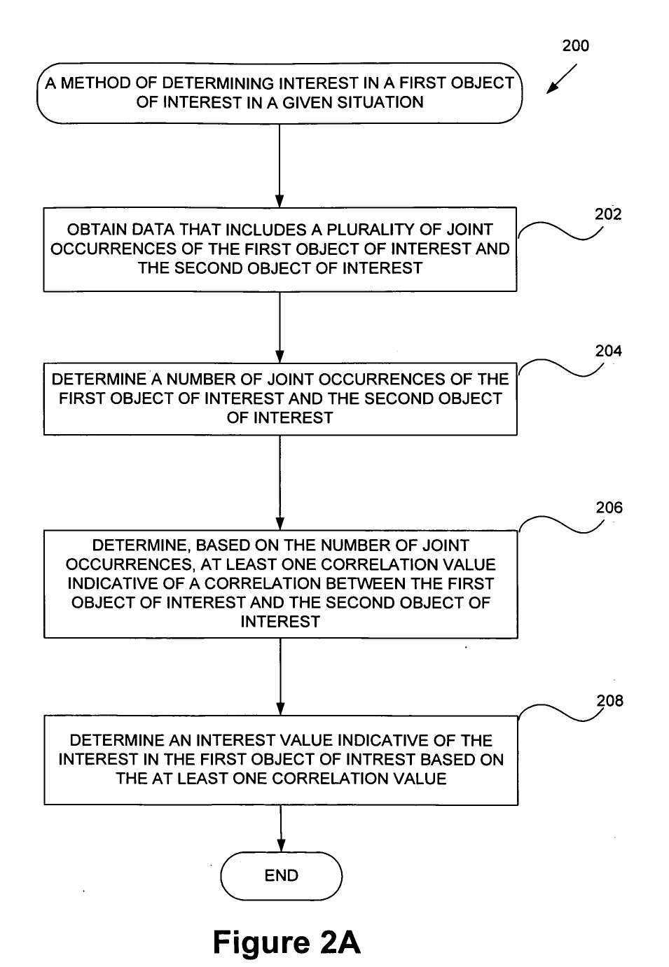

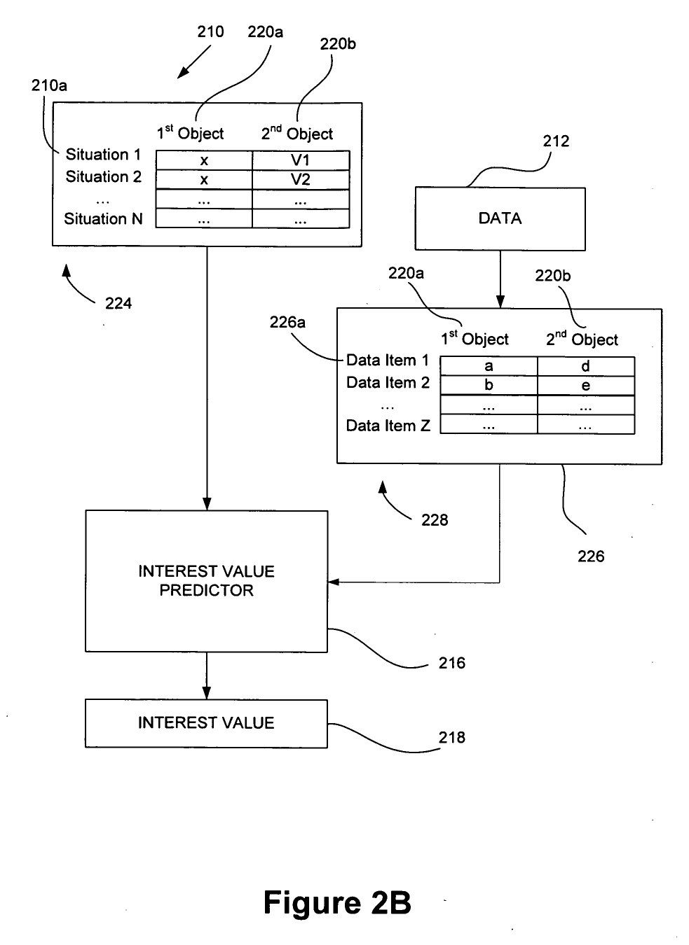

FIG. 2A shows one embodiment of a computer implemented method 200 for determining interest in a first object of interest, given a situation. The steps 202, 204, 206 and 208 of FIG. 2A are described in conjunction with FIG. 2B, which illustrates data 212, joint occurrence data components 226, interest value predictor 216, interest value 218 and situation-based interest rating components 210. The situation-based interest rating components 210 relate to various situations 224, first object 220a and second object 220b.

Situation-based interest rating components 210 represent the interests of one or more users, given various situations 1 through N. Components 210 are separated into rows. Component 210a, for instance, indicates that the interest of the user in the second object 220b is V1 when the user is in situation 1. V1 indicates the intensity of the user's interest in the second object. It should be appreciated that the interests in first object 220a are unknown for all situations 1 through N, as indicated by the column of x's. To use a simple example, if situation 1 represents “at home in the evening,” first object 220a represents “pop music,” second object 220b represents “movies,” and V1=4 out of a range of 0 to 5, then component 210a indicates that the user on average has a relatively high degree of interest in movies when the user is at home in the evening, but has an unknown level of interest in pop music at the same time and location. Components 210 may be derived from a data log that tracks a user's behavior e.g., the observation of a user's utilization of the Internet, a device, various applications, etc. Although components 210 contain information pertaining to a situation, this is not a requirement and components 210 could contain only information relating to interests and/or other information unrelated to a person's situation.

In step 202 of FIG. 2A, data 212 of FIG. 2B is obtained. In the illustrated embodiment, data 212 refers to Internet-based media, such as web pages, online audio and video. Data 212, however, may involve a wide range of information types and sources. In particular embodiments, data 212 was not used, directly or indirectly, to generate values for one or more of the situation-based interest rating components 212.

In accordance with step 204 of FIG. 2A, a number of joint occurrences of first object 220a and second object 220b in data 212 is determined. These occurrences can be identified in a variety of ways. For example, a search engine (e.g., Yahoo! or Google) may be used to search the documents in data 212. The query terms for the search engine are based on first object 220a and second object 220b. The search generates joint occurrence data components 226. One advantage of drawing upon external data resources (e.g., search engines) is that they can be used to establish relationships between seemingly widely disparate objects and/or topics that have no obvious semantic connection to one another.

Joint occurrence data components 226 include references to data items 228, which are part of data 212. At least some of data items 228 are individual web pages and/or files. Joint occurrence data components 226 indicate whether the first object 220a, the second object 220b or both appear in a particular data item. To use a simple example, if a=1, b=1, c=1, d=0, first object 220a is “pop music” and second object 220b is “movies,” then component 226a indicates that data item 1 contains references to both pop music and movies, but data item 2 contains references only to pop music. In the illustrated embodiment, values such as a, b, c and d can only be 0 or 1, and thus only take into account whether there are any references at all to the first and second objects in the respective data items 228. This, however, is not a requirement. Joint occurrence data components 226 may be computed using a variety of techniques, depending on the needs of a particular application. For instance, joint occurrence data components 226 can also identify how many occurrences of each object took place in each data item. What amounts to an “occurrence” or “joint occurrence” may vary from application to application. In some embodiments, an “occurrence” may refer to the appearance of one or more keywords, concepts or key phrases appearing in one of the data items 228. Various other metrics may be used to measure the degree to which a particular object of interest occurs or is represented in a particular data item.

In step 206 of FIG. 2A, at least one correlation value is determined that indicates a correlation between first object 220a and second object 220b of FIG. 2B. In the illustrated embodiment, such correlation values are based on the number of data items 228 and the number of occurrences, which are represented in part by variables a, b, c and d. In the illustrated embodiment, second object 220b appears in each one of Z data items 226 and first object 220a appears in X of Z data items 228. As a result, the associated correlation value between first object 220a and second object 220b is X/Z. This correlation value X/Z represents the strength and/or frequency of association between the first object 220a and the second object 220b. The correlation value relating first object 220a to second object 220b may be calculated in other ways as well. For example, the correlation value may be based on co-occurrence, Pearson's correlation, cosine correlation, conditional probability or other approaches.

Interest value predictor 216 receives situation-based interest rating components 210 and the one or more correlation values from joint occurrence data components 226. As indicated by step 208 of FIG. 2A, interest value predictor 216 of FIG. 2B generates the interest value 218. Interest value 218 is intended to replace the unknown value (marked by an “x”) for first object 220a in one of the situation-based interest rating components 210.

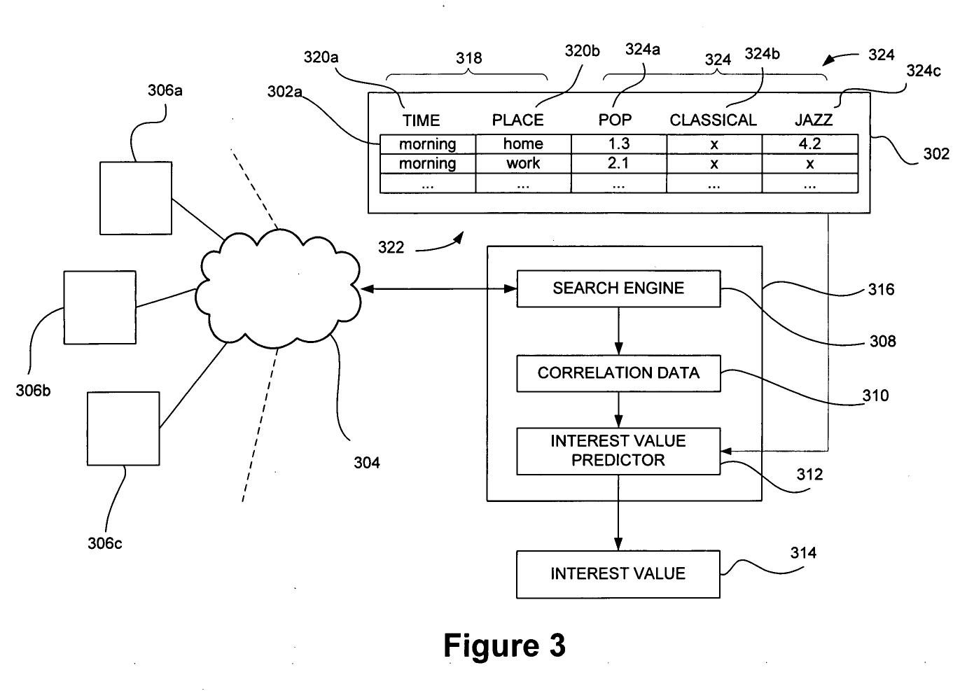

Interest value predictor 216 may compute interest value 218 in a variety of ways. For instance, interest value 218 may be computed using a simple weighted sum formula. The “weights” in this weighted sum formula may be the correlation values. Thus, for situation-based interest rating component 210a, which only has 1 known object of interest (i.e., second object 220b), the interest value for first object 220a=V1 (the interest value for second object 220b), since there is only 1 weighted value in the formula. Interest value predictor 216 may also use a weighted sum when there are known interest values for multiple objects of interest and/or multiple correlation values. An example of this approach is described in connection with FIG. 3.

In other embodiments, interest value predictor 316 bases the interest value 218 on the correlation value. To use a simple example, assume V1=interest in first object 220a and V2=interest in second object 220b and C=correlation value relating first object 220a and second object 220b. Assume further that V2 is known, V1 is unknown and that interest value predictor 316 is predicting an interest value 218 that indicates an interest in first object 220a i.e., V1. Interest value predictor 316 may estimate V1 according to the exemplary scheme below:

$$V 1 = \{ \begin{matrix}V 2 & if C = 0.9 or greater \\ C * V 2 & if 0.9 > C > 0.75 \\ unknown & if C < .75\end{matrix}$$

The above scheme indicates that V1 may be calculated based on V2 when C reaches a specific predetermined value. V2 is computed in different ways based on V2 and C depending on the range of predetermined values that C falls into. Additionally, if C falls below a particular predetermined value, V1 is not determined, because C appears to indicate that V2 is not a dependable indicator of V1. Various formulas, algorithms, conditions and/or predetermined values may be used to relate interest values for first object 220a and first object 220b.

It should be appreciated that the method illustrated in FIGS. 2A and 2B is particularly useful in “cold start” situations, e.g. when there is no data on the interests in first object 220a. Consider, for example, a computing device that tracks the activities of a user across various situations. The computing device, which is a mobile phone, laptop, computer or other device, may easily gather data related to the user's utilization of the computing device, any software stored thereon and/or the environment immediately surrounding the device. This exemplary computer device, however, may lack the ability to collect data regarding another, non-device-related interests (e.g., bowling or politics.) In such “cold start” environments, a computing device implementing the illustrated embodiment of FIG. 2B may estimate such non-device-related interests by accessing data 212 (e.g., the Internet) and generating joint occurrence data 226.

As noted earlier, interest values for first object 220a may be based on the interest values for more than one interest object. In FIG. 2B, there are only two objects of interest and the interest in the first object 220a was based on the interest in the second object 220b. In some embodiments, there are multiple objects of interest with known values. Particular embodiments involve finding joint occurrences of first object 220a and each one of the multiple objects in data 212 and formulating multiple correlation values. Each of these correlation values may be used as weights in a weighted sum formula to predict an interest value 218 for first object 220a.

FIG. 3 illustrates an example of such an approach. FIG. 3 presents situation-based interest rating components 302, Internet 304, Internet nodes 306a, 306b and 306c and computing device 316. Computing device 316 receives and/or stores situation-based interest rating components 302 and includes at least an interface to search engine 308 and interest value predictor 312. Computing device 316 may include one or more processors and/or various discrete devices. For example, portions of computer device 316 may be divided among one or more servers, clients, mobile devices and/or computers.

Initially, situation-based interest rating components 302 are obtained by computing device 316. Components 302 associate various situations 318 with objects of interest 324. The various objects of interest 324a, 324b and 324c are pop music, classical music and jazz music, respectively. In the illustrated embodiment, components 302 are situation-aware and provide information relating to various situations, but this is not a requirement. Components 302 can also be limited to information that does not relate to situations, contexts and/or external circumstances.

Each situation 318 is characterized by two context variables 320a and 320b and their associated context values. The context variables 320a and 320b represent time and place, respectively. Each context variable 320a and 320b has various possible context values. The possible context values for context variable 320a are morning, midday and evening. The possible context values for context variable 320b are work and home.

Each situation-based interest rating component 302 indicates the interests of a user in a variety of objects of interest when the user is in a particular situation. For instance, situation-based interest rating component 302a indicates that a user, on average, has an interest rated at 1.3 in pop music and 4.2 in jazz music when he is at home in the morning. Each of these interest values is from a range of values between 0 and 5, although any range of values may be used. The interest of the user in classical music is unknown in any situation, as indicated by the “x's” in the column for classical music. The above interest values are derived from data accumulated by computing device 316 about the user.

The computing device 316, using search engine 308, then obtains text-based data items from Internet 304. A text-based data item can include any kind of data type that includes words, such as a web page, document, audio, video or text file, etc. Internet 304 includes a network of numerous routers, servers, clients and/or other devices, such as nodes 306a-c. Search engine 308 may be a private search engine or any commonly known, publicly accessible search engine on the Internet 304, such as Yahoo! or Google. Search engine 308 conducts a search of Internet 304 using search terms. Each search term can include one or more keywords associated with the known interest objects of situation-based interest rating component 302a i.e., pop music and jazz music. The exact way in which the search is made and/or keywords are submitted to search engine 308 can vary, depending on the needs of a particular application. In certain instances, a single interest object (e.g., running) may result in the use of one or more keywords that reflect various aspects of the interest object (e.g., jogging, run, marathon, etc.) Data items acquired through the search may be subjected to additional processing steps. For example, stopping words (e.g., I, is, etc.) may be removed and/or keywords in the data items may be stemmed e.g., a word such as “running” may be converted to its root, “run.” In particular embodiments, the search extends to the entire Internet 304. In other embodiments, the search is restricted to one or more nodes, servers, databases, domains and/or sites on a private network and/or Internet 304.

In response to the queries, computing device 316 receives first and second groups of text-based data items, respectively. The first group includes Al data items that each contain at least one occurrence of the keywords related to “pop music.” The second group includes A2 data items that each contain at least one occurrence of the keywords related to “jazz music.” Among the A1 data and A2 data items, there are B1 and B2 data items, respectively, that also each contain at least one occurrence of keywords related to “classical music.”

Afterward, classical-pop and classic-jazz correlation values are determined and correlation data 310 is generated. The classical-pop correlation value is calculated by dividing the number of data items having joint occurrences of “pop music” and “classical music” keywords (i.e., B1) by the number of data items having at least one occurrence of “pop music” keywords (i.e., A1). Hence, the classical-pop correlation value is B1/A1. Calculated in an analogous manner, the classical-jazz correlation value is B2/A2. These values form correlation data 310, which is sent to interest value predictor 312.

Interest value predictor 312 generates the interest value 314 based on correlation data 310 and existing interest values for pop music and classical music in situation-based interest rating component 302a. This interest value will replace the unknown value for classical music in component 302a. Interest value 314 may be calculated in a variety of ways, depending on the needs of a particular application. This calculation, for example, may involve the weighted sum formula below:

$${P}_{s , j} = \frac{{\sum }_{i = 1}^{K} Pr ( j \vert i ) \times {V}_{s , i}}{{\sum }_{i = 1}^{K} Pr ( j \vert i )}$$

In the above exemplary equation, P is the predicted interest value for a specific interest object j, given a situation s. Pr refers to the conditional probability that interest object j will occur when interest object i occurs (e.g., the classical-pop and classical-jazz correlation values.) In particular embodiments, Pr could involve co-occurrence, Pearson correlation, cosine correlation and/or other types of relationships between various interest objects. V refers to the interest value for the interest object i, given the situation s.

Interest value predictor 312 may use the above or different prediction equations to fill in the unknown interest values for classical music in one or more of interest rating components 302. Additionally, the methods described in this application may be modified and/or combined with other methods for predicting interest values, such as those described in the following three patent applications: U.S. patent application Ser. No. 12/343,392, entitled “Rating-based Interests in Computing Environments and Systems”; U.S. patent application Ser. No. 12/343,393, entitled “Semantics-based Interests in Computing Environments and Systems”; and U.S. patent application Ser. No. 12/343,395, entitled “Context-based Interests in Computing Environments and Systems.” (These three patent applications are incorporated herein in their entirety for all purposes.) For example, computing device 316 may determine some of the unknown interest values in situation-based interest rating components 302 based on interest values 314 and correlation data 310. As a result, at least some situation-based interest rating components 302 will have interest values for both interest object 324b as well as at least one of interest objects 324a and 324c. Afterward, other unknown interest values in components 302 may be determined using the techniques of the aforementioned applications. Additionally, context variables, context values, situations, situation-based interest rating components, prediction equations, computing devices and/or other aspects of the present application may be modified according to the features described in these applications.

The various aspects, features, embodiments or implementations of the invention described above can be used alone or in various combinations. The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A computer-implemented method of determining interest in a first object of interest in a given situation of a plurality of situations, wherein interest in said first object of interest is unknown in said given situation and wherein interest in a second object of interest is known in said given situation, said computer-implemented method comprising:
obtaining data that includes a plurality of joint occurrences of said first object of interest and said second object of interest;
(a) determining a first number of joint occurrences of said first object of interest and said second object of interest in said data;
(b) determining, based on said first number of joint occurrences, at least one correlation value indicative of a first correlation between said first object of interest and said second object of interest; and
(c) determining an interest value indicative of said interest in said first object of interest based on said at least one correlation value.

2. The computer-implemented method of claim 1, wherein each one of said plurality of situations includes a plurality of context variables, each one of said plurality of context variables having a plurality of possible context values.

3. The computer-implemented method of claim 2, wherein said plurality of situations includes set of all possible combinations of said pluralities of context variables and context values and wherein interest in said first object of interest is unknown for said set of all possible combinations.

4. The computer-implemented method of claim 1, wherein:
interest in a third object of interest is known in said given situation;
said data includes joint occurrences of said first object of interest and said third object of interest;
the method further comprises: (d) determining a second number of joint occurrences of said first object of interest and said third object of interest;
said at least one correlation value is based on said first number of joint occurrences and said second number of joint occurrences; and
said at least one correlation value is indicative of said first correlation and a second correlation between said first object of interest and said third object of interest.

5. The computer-implemented method of claim 4, wherein:
determining (c) includes calculating a weighted sum that is based on said at least one correlation value, said interest in said second object of interest and said interest in said third object of interest.

6. The computer-implemented method of claim 1, wherein there is a plurality of objects of interest including said first and second objects of interest and said interest value is not based on predetermined rules that are applied differently to different ones of said objects of interest.

7. The computer-implemented method of claim 1, wherein the at least one correlation value is based on at least one of a group consisting of: conditional probability, cosine correlation and Pearson's correlation.

8. A computer-implemented method of determining interest in a keyword in a given situation of a plurality of situations, comprising:
(a) obtaining a plurality of situation-based interest rating components for said plurality of situations, wherein each one of said plurality of situation-based interest rating components includes a first interest value, a second interest value, a third interest value and one of said plurality of situations, said first, second and third interest values indicative of interests in first, second and third keywords respectively in said one of said plurality of situations, wherein said first interest values are unknown for said plurality of situations and wherein said second and third interest values are known at least for said given situation;
(b) obtaining a first plurality of text-based data items and a second plurality of text-based data items from a multiplicity of text-based data items, said first and second pluralities of text-based data items selected from said multiplicity of text-based data items based on said second and third keywords respectively, each one of said first plurality of text-based data items including at least one occurrence of said second keyword, each one of said second plurality of text-based data items including at least one occurrence of said third keyword, said first and second pluralities of text-based data items including at least one occurrence of said first keyword;
(a) determining a first correlation value based on comparing the number of occurrences of said first keyword in said first plurality of text-based data items and the number of occurrences of said second keyword in said first plurality of text-based data items;
(b) determining a second correlation value based on comparing the number of occurrences of said first keyword in said second plurality of text-based data items and the number of occurrences of said second keyword in said second plurality of text-based data items;
predicting, based on said first correlation value, said second correlation value, and said known second and third interest values, an estimated interest value indicative of interest in said first keyword in said given situation.

9. The computer-implemented method of claim 7, wherein each one of said plurality of situations includes a plurality of context variables, each one of said plurality of context variables having a plurality of possible context values.

10. The computer-implemented method of claim 8, wherein said plurality of situations includes set of all possible combinations of said pluralities of context variables and context values and wherein said first interest values are unknown for said set of all possible combinations.

11. The computer-implemented method of claim 7, wherein said estimated interest value includes calculating a weighted sum that is based on said first correlation value, said second correlation value, said known second interest value for said given situation and said known third interest value for said given situation.

12. The computer-implemented method of claim 8, wherein said text-based data items include web documents and said obtaining (b) is performed by an Internet search engine.

13. A computing system for determining an interest in a first object of interest in a given situation of a plurality of situations, wherein interest in said first object of interest is unknown in said given situation and wherein interest in a second object of interest is known in said given situation and wherein said computing system is operable to:
obtain data that includes a plurality of joint occurrences of said first object of interest and said second object of interest;
(a) determine a first number of joint occurrences of said first object of interest and said second object of interest in said data;
(b) determine, based on said first number of joint occurrences, at least one correlation value indicative of a first correlation between said first object of interest and said second object of interest; and
(c) determine an interest value indicative of said interest in said first object of interest based on said at least one correlation value.

14. The computing system of claim 13, wherein the computing system includes at least one server and at least one client.

15. The computing system of claim 13, wherein each one of said plurality of situations includes a plurality of context variables, each one of said plurality of context variables having a plurality of possible context values.

16. The computing system of claim 15, wherein at least one of the context variables is based on one or more of the following:
a) an environmental factor and/or element;
b) an environmental factor and/or element associated with one or more humans interacting with one or more applications on the computing system;
c) environmental context of use associated with an environment of one or more humans as they interact with one or more active applications on the computing system;
d) a geographical and/or physical factor and/or element;
e) time, date, location, mode, mode of operation, condition, event, temperature, speed and/or acceleration of movement, power and/or force;
f) presence of one or more external components and/or devices;
g) presence of one or more active components operating on one or more external devices in a determined proximity of said device; and
h) one or more physiological and/or biological conditions associated with one or more persons interacting with the computing system.

17. The computing system of claim 13, wherein:
interest in a third object of interest is known in said given situation;
said data includes joint occurrences of said first object of interest and said third object of interest;
the method further comprises: (d) determining a second number of joint occurrences of said first object of interest and said third object of interest;
said at least one correlation value is based on said first number of joint occurrences and said second number of joint occurrences; and
said at least one correlation value is indicative of said first correlation and a second correlation between said first object of interest and said third object of interest.

18. The computing system of claim 17, wherein:
determining (c) includes calculating a weighted sum that is based on said at least one correlation value, said interest in said second object of interest and said interest in said third object of interest.

19. The computer-implemented method of claim 13, wherein the at least one correlation value is based on at least one of a group consisting of: conditional probability, cosine correlation and Pearson's correlation.

20. A computer readable storage medium that includes executable computer code embodied in a tangible form operable to determine an interest in a first object of interest in a given situation of a plurality of situations, wherein interest in said first object of interest is unknown in said given situation and wherein interest in a second object of interest is known in said given situation and wherein said computer readable medium comprises:
executable computer code operable to obtain data that includes a plurality of joint occurrences of said first object of interest and said second object of interest;
executable computer code operable to (a) determine a first number of joint occurrences of said first object of interest and said second object of interest in said data;
executable computer code operable to (b) determine, based on said first number of joint occurrences, at least one correlation value indicative of a first correlation between said first object of interest and said second object of interest; and
executable computer code operable to (c) determine an interest value indicative of said interest in said first object of interest based on said at least one correlation value.

21. The computer-implemented method of claim 1, wherein the first object of interest and the second object of interest are not part of the same domain.

22. The computer-implemented method of claim 1, wherein the determining (c) of the interest value is not based on relative positions of the first and second objects of interest within a tree-like structure.

23. A computer-implemented method of determining interest in a first object of interest, wherein a first interest value indicative of an interest in said first object of interest is unknown and wherein a second interest value indicative of an interest in a second object of interest is known, said computer-implemented method comprising:
obtaining a first search term representing said first object of interest and a second search term representing said second object of interest;
transmitting the first and second search terms to a search engine configured to search a multiplicity of text-based data items stored on a network;
receiving data from said search engine indicating a plurality of joint occurrences of said first search term and said second search term in each of a plurality of said text-based data items;
determining at least one correlation value based on the received data, the correlation value indicative of a frequency that said first search term appears together with said second search term in one of the multiplicity of text-based data items; and
computing said first interest value indicative of said interest in said first object of interest based on said at least one correlation value and said second interest value.

24. The computer-implemented method of claim 23, wherein:
said multiplicity of text documents include a multiplicity of words, each text-based data item including a plurality of words;
the first and second search terms each include at least one word of the multiplicity of words; and
each of the plurality of joint occurrences involves a joint appearance of the at least one word of the first search term and the at least one word of second search term among the plurality of words of one of the multiplicity of text-based data items.
